(19) United States
(12) Patent Application Publication
(10) Pub. No.: US 2015/0067538 A1
(43) Pub. Date: Mar. 5, 2015

(54) APPARATUS AND METHOD FOR CREATING EDITABLE VISUAL OBJECT

(71) Applicant: Electronics and Telecommunications Research Institute, Daejeon (KR)

(72) Inventors: Ji-Won LEE, Daejeon (KR); Jae-Sook CHEONG, Daejeon (KR); Sang-Hyun JOO, Daejeon (KR); Si-Hwan JANG, Seoul (KR)

(21) Appl. No.: 14/446,166

(22) Filed: Jul. 29, 2014

(30) Foreign Application Priority Data
Sep. 3, 2013 (KR) 10-2013-0105333
Jan. 2, 2014 (KR) 10-2014-0000332

(51) Int. Cl. G06F 3/0484; H04L 29/06; G06F 3/0482

(52) U.S. Cl. CPC G06F 3/04842; G06F 3/0482; H04L 65/403
USPC 715/753

(57) ABSTRACT

Disclosed herein are an apparatus and method for creating an editable visual object. In accordance with an embodiment, the apparatus for creating an editable visual object includes an interface unit for providing an editable visual object creation interface to a user. A template display unit displays a basic template for an editable visual object desired to be created by the user on the interface. A visual object creation unit is configured to, if the user edits the displayed basic template, create an editable visual object based on editing information.

### CROSS REFERENCE TO RELATED APPLICATIONS

This application claims the benefit of Korean Patent Application Nos. 10-2013-0105333, filed on Sep. 3, 2013 and 10-2014-0000332, filed on Jan. 2, 2014, which are hereby incorporated by reference in their entirety into this application.

### BACKGROUND OF THE INVENTION

1. Technical Field

The present invention relates generally to an apparatus and method for creating an editable visual object and, more particularly, to an apparatus and method for creating an editable visual object, which can freely edit visual objects so that free expression is possible depending on the intention of a user upon performing visual communication.

2. Description of the Related Art

Conventional asynchronous message-related services for online communication are mainly based on text, and visual communication means is limited only to the transmission of multimedia files such as images or pictures based on emoticons or flashcons. However, the number of cases where, in addition to emoticons, various types of visual information are used for online communication has gradually increased.

For example, as shown in FIG. 1, a user may more easily memorize English words by utilizing pictures instead of simply describing the words using text-based characters so as to memorize the English words online. Further, recently, as shown in FIG. 2, a user may express his or her emotion by a designated animation using a new type of flashcon upon chatting with another party in a messenger program, thus allowing the user to effectively express his or her emotion by animations, sounds, etc.

However, such a conventional method is configured to merely select previously created visual objects depending on the user's preference, and transmit the selected visual objects to another user. Further, Korean Patent Application Publication No. 10-2011-0055951 discloses a user object creation system and method, but there is a limitation when users create editable visual objects that precisely and freely express their emotions or like.

### SUMMARY OF THE INVENTION

Accordingly, the present invention has been made keeping in mind the above problems occurring in the prior art, and an object of the present invention is to provide an apparatus and method for creating an editable visual object, which allow a user to freely edit and create an editable visual object.

In accordance with an aspect of the present invention to accomplish the above object, there is provided an apparatus for creating an editable visual object, including an interface unit for providing an editable visual object creation interface to a user, a template display unit for displaying a basic template for an editable visual object desired to be created by the user on the interface, and a visual object creation unit for, if the user edits the displayed basic template, creating an editable visual object based on editing information.

Preferably, the interface unit may display an authoring tool for editing one or more of an attribute element, a basic element, and an action element of the editable visual object on the interface.

Preferably, the attribute element may include one or more of version, identification (ID), creation date, and user attributes of the editable visual object.

Preferably, the basic element may include one or more of a basic editing element and a dynamic editing element for the editable visual object.

Preferably, the basic editing element may include one or more of a position, at which the editable visual object is to be disposed, and a color, a size, flip/non-flip, and rotation/non-rotation of the editable visual object.

Preferably, the dynamic editing element may include one or more action elements previously generated based on actions that can be taken by the editable visual object.

Preferably, the action element may include one or more of a basic action element and a specialized action element for the editable visual object.

Preferably, the basic action element may include one or more predefined action elements applicable to two or more editable visual objects.

Preferably, the specialized action element may include one or more action elements determined based on a basic element edited by the user for the editable visual object.

Preferably, the template display unit may be configured to, if information about the editable visual object is input by the user, search a template database (DB) for a basic template of the editable visual object using the editable visual object information, and display a found basic template on the interface.

Preferably, the visual object creation unit may create a new editable visual object by combining two or more editable visual objects selected by the user, and if a new idea is generated for the created new editable visual object, determines an idea to be assigned to the new editable visual object.

In accordance with another aspect of the present invention to accomplish the above object, there is provided a method for creating an editable visual object, including providing an editable visual object creation interface to a user, displaying a basic template for an editable visual object desired to be created by the user on the interface, and if the user edits the displayed basic template, creating an editable visual object based on editing information.

Preferably, providing the interface may include displaying an authoring tool for editing one or more of an attribute element, a basic element, and an action element of the editable visual object on the interface.

Preferably, the basic element may include one or more of a basic editing element and a dynamic editing element for the editable visual object.

Preferably, the action element may include one or more of a basic action element and a specialized action element for the editable visual object.

Preferably, the basic action element may include one or more predefined action elements applicable to two or more editable visual objects.

Preferably, the specialized action element may include one or more action elements determined based on a basic element edited by the user for the editable visual object.

Preferably, creating the visual object may include inputting information about two or more editable visual objects selected by the user, combining the selected two or more editable visual objects to create a new editable visual object, and if a new idea is generated for the created new editable visual object, determining an idea to be assigned to the new editable visual object.

### BRIEF DESCRIPTION OF THE DRAWINGS

FIGS. 1 and 2 are diagrams showing examples of a typical visual communication method;

FIG. 3 is a block diagram showing an apparatus for creating an editable visual object according to an embodiment;

FIGS. 4 to 6 are diagrams showing an example of an interface provided by the apparatus for creating an editable visual object according to an embodiment;

FIG. 7 is a diagram showing another example of an interface provided by the apparatus for creating an editable visual object according to an embodiment;

FIG. 8 is a flowchart showing a method of creating an editable visual object according to an embodiment; and

FIG. 9 is a flowchart showing a method of creating an editable visual object according to another embodiment.

FIG. 10 is an embodiment of the present invention implemented in a computer system.

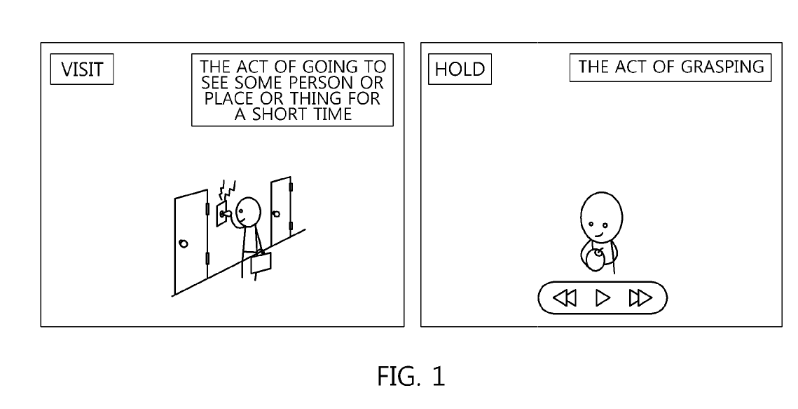

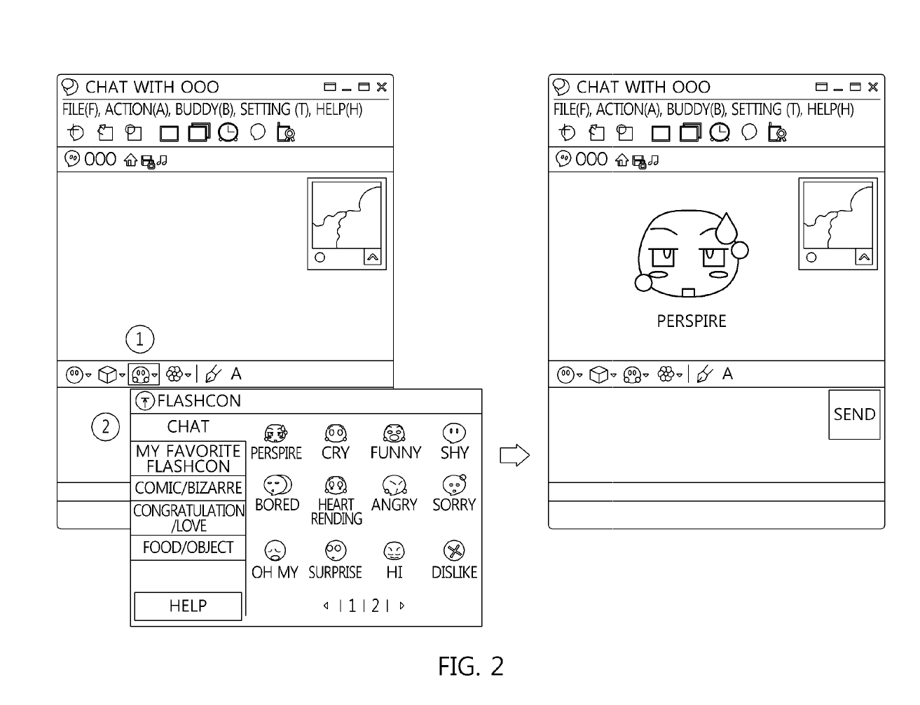

### DESCRIPTION OF THE PREFERRED EMBODIMENTS

Details of other embodiments are included in detailed description and attached drawings. The features and advantages of technology disclosed in the present invention and methods for achieving them will be more clearly understood from a detailed description of the following embodiments taken in conjunction with the accompanying drawings. Reference now should be made to the drawings, in which the same reference numerals are used throughout the different drawings to designate the same or similar components.

Hereinafter, embodiments of an apparatus and method for creating an editable visual object will be described in detail with reference to the attached drawings.

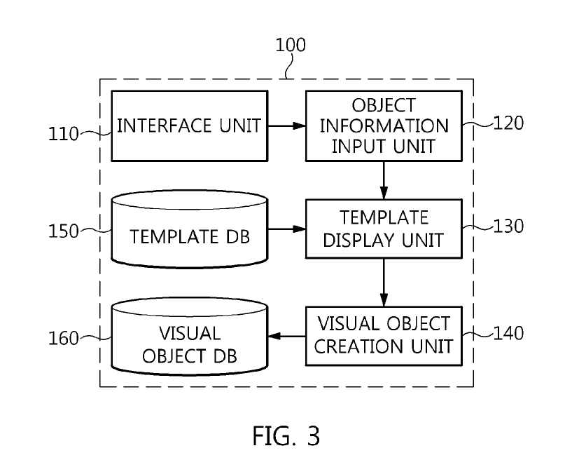

FIG. 3 is a block diagram showing an apparatus for creating an editable visual object according to an embodiment.

Referring to FIG. 3, an apparatus 100 for creating an editable visual object includes an interface unit 110, an object information input unit 120, object information input unit 120, a template display unit 130, a visual object creation unit 140, a template database (DB) 150, and a visual object DB 160.

The interface unit 110 provides an editable visual object creation interface to a user. The interface unit 110 is configured to, if a visual object creation request is input by the user, display an editable visual object creation interface on the display of a user terminal Here, the user terminal may include a mobile terminal such as a smart phone or a smart pad, a notebook computer, a desktop Personal Computer (PC), a server, or the like.

The interface unit 110 may display an authoring tool for editing one or more of the attribute element, the basic element, and the action element of an editable visual object on the interface. In this case, the interface may include one or more of an attribute element area, a basic element area, and an action element area. The authoring tool displayed on the interface may include various graphical objects, for example, a text input box, a drop-down menu, an option button, a check box, etc., so that the user can easily edit the editable visual object.

In this case, the attribute element may include the version, Identification (ID), creation date, user attributes, etc. of an editable visual object to be created.

Further, the basic element, which denotes the editable element of the editable visual object, may include a basic editing element required to edit the static element of the editable visual object, a template element required to select the basic shape of the editable visual object, and a dynamic editing element required to edit a dynamic element.

In this case, the basic editing element, which is a static editing element that can be applied in common to two or more editable visual objects, may include, for example, elements such as a position, at which each editable visual object is to be disposed, and the color, size, flip/non-flip, rotation/non-rotation, label, combination, and transparency of the editable visual object.

Here, the combination element denotes an element for selecting another editable visual element desired to be combined with an editable visual object. For example, when a visual object currently being edited is “eye”, if the visual object “water” is selected as a combination element, a shape in which the visual object currently being edited sheds tears may be implemented.

In this case, the dynamic editing element, which is an element required to define the moving shape of an editable visual object, denotes an editing element required to define the motion of an eye, such as “opened and closed” when a visual object currently being edited is, for example, “eye.”

Meanwhile, the action element may include a basic action element which is a more detailed dynamic element applicable to two or more editable visual objects and a specialized action element which is a dynamic element specialized in and applicable to a visual object currently being edited.

For example, the basic action element may include elements required to select detailed actions such as whether to move an editable visual object to a position designated by the user, or to highlight the editable visual object by reducing/enlarging or blinking the editable visual object.

Further, the specialized action element denotes an element that may be selected based on the dynamic editing element of the basic element, and may include various types of detailed actions selectable with respect to “opened and closed” selected in the dynamic editing element when a visual object currently being edited is, for example, “eye”. In this case, the detailed actions may be set in advance in various manners, and may include, for example, “blinking” or “closed for 1 second and opened for 3 seconds.”

The object information input unit 120 inputs information about an editable visual object desired to be created from the user. For example, the information about the editable visual object input by the user may be information about the target of the editable visual object, such as expression, an eye, a mouth, a face, time, hour, minute, and second.

The template display unit 130 is configured to, if the information about the editable visual object is input by the user, search the template DB 150 for the basic template of the corresponding editable visual object, and display the found basic template on the interface.

In this case, the template DB 150 may store, as a template, an editable visual object newly created by the user through the interface, as well as the templates of various editable visual objects previously created by a developer.

The visual object creation unit 140 is configured to, if the user edits the editable visual object in the interface, create a final editable visual object using pieces of editing information. In this case, the visual object creation unit 140 may generate the metadata of the editable visual object based on pieces of information input by the user, and store the metadata in the visual object DB 160.

Further, the editable visual object newly created by the user may be stored as a basic template in the template DB 150. By means of this, various users may create various desired editable visual objects using editable visual objects created by other users in addition to the templates created by developers, and utilize the created editable visual objects for communication.

Meanwhile, in accordance with an additional embodiment, each user may combine a plurality of previously created editable visual objects to create a new editable visual object.

That is, when the user inputs information about two or more editable visual objects desired to be combined with each other, the interface unit 110 may display an interface including an attribute element area, a basic element area, and a configuration Editable Visual Object (EVO) area.

The template display unit 120 may search the templates of editable visual objects input by the user and display elements corresponding to the attribute element area, the basic element area, and the configuration EVO area.

In this case, the template display unit 120 may display the values of the templates of the editable visual objects, input by the user, as basic values in the corresponding editing elements of the interface, and may add various values to graphical objects such as a drop-down menu or an option button so that the user may change the basic values.

As described above, the attribute element may include the version, ID, creation date, user attributes, etc., and the basic element may include a basic editing element applicable in common to two or more editable visual objects. Further, the configuration EVO may include editable elements for individual editable visual objects to be combined.

If the user edits editing elements in the attribute element, the basic element, and the configuration EVO which are displayed on the interface, the visual object creation unit 140 creates a new editable visual object based on the pieces of editing information. In this case, the visual object creation unit 140 determines whether individual editable visual objects input by the user may be combined with each other, and may combine editable visual objects except editable visual objects that cannot be combined.

In this case, when a new idea is generated for the created new editable visual object, the visual object creation unit 140 may determine which one of an existing idea and the new idea is to be applied to the new editable visual object.

For example, when a new idea is generated, the visual object creation unit 140 requests the user to select any one of an existing idea and the new idea, and may use the idea selected by the user as the idea of the new editable visual object. Alternatively, the visual object creation unit 140 may use any one idea, for example, a newly generated idea, as the idea of the new editable visual object in conformity with a preset criterion.

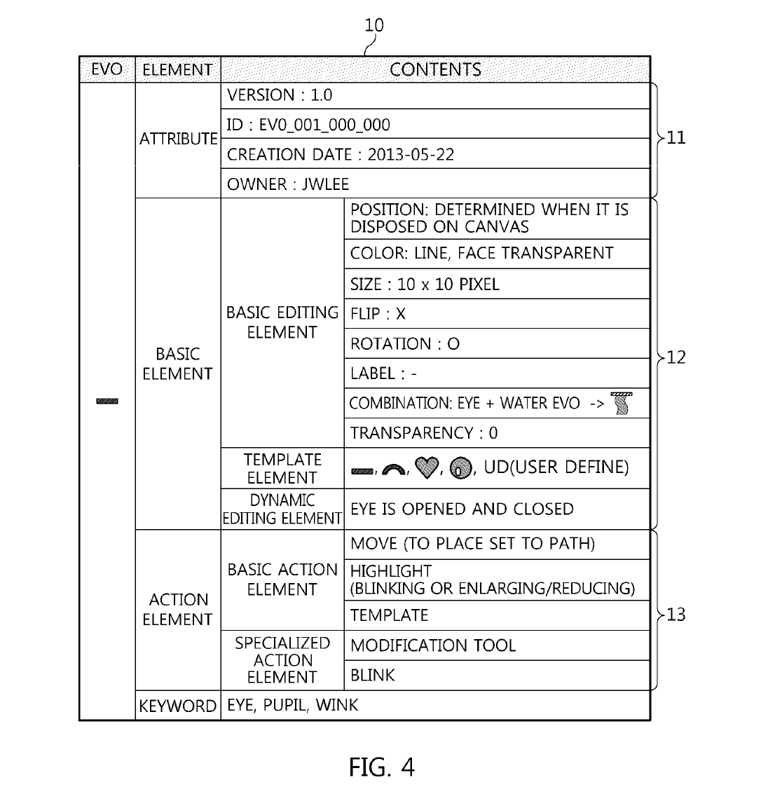

FIGS. 4 to 7 are diagrams showing an example of an interface provided by the apparatus for creating an editable visual object according to the embodiment of FIG. 3.

Embodiments in which the editable visual object creation apparatus 100 of FIG. 3 creates an editable visual object will be described with reference to FIGS. 4 to 7.

FIGS. 4 to 6 illustrate an interface 10, displayed by the interface unit 110 on the display of the user terminal, according to an embodiment. The interface 10 may include an attribute element area 11, a basic element area 12, and an action element area 13.

In FIG. 4, editing elements required to create editable visual objects for “eye” are displayed in the respective areas 11, 12, and 13.

As described above, when the object information input unit 120 inputs “eye” as information about an editable visual object from the user, the template display unit 130 searches the template DB 150 for basic templates matching “eye” and display the basic templates in the corresponding editing elements.

If basic values for the respective editing elements are displayed on the interface 10, the user may check the basic values and change the values of desired editing elements. For example, as shown in the drawing, the colors or sizes of the basic editing elements may be edited. The motion of the eye may be expressed by changing a dynamic editing element to “eye is opened and closed.”

Alternatively, a highlight effect may be assigned to the editable visual object “eye” by changing the basic action element of the action element to “highlight (blinking or enlargement/reduction)”.

Further, as shown in the drawing, the user may enter a keyword such as “eye,” “pupil,” or “wink” into the interface 10, thus enabling the keyword to be easily searched for in later digital communication.

In this way, when the user changes individual editing elements so as to create his or her desired object “eye” via the interface 10, the visual object creation unit 140 may create an editable visual object having a shape in which the eye is blinking, based on the editing elements.

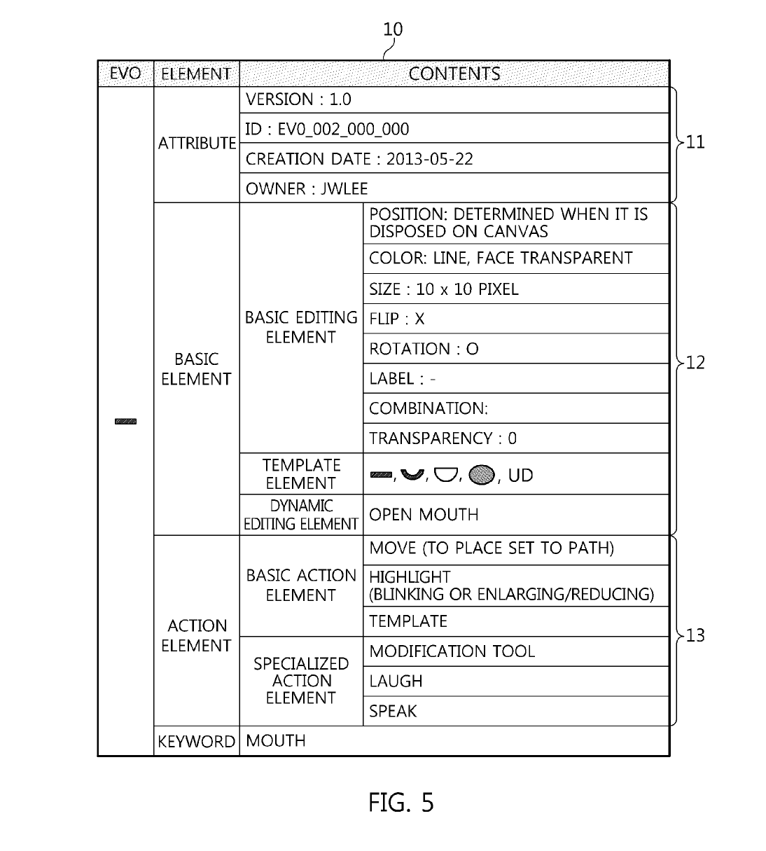

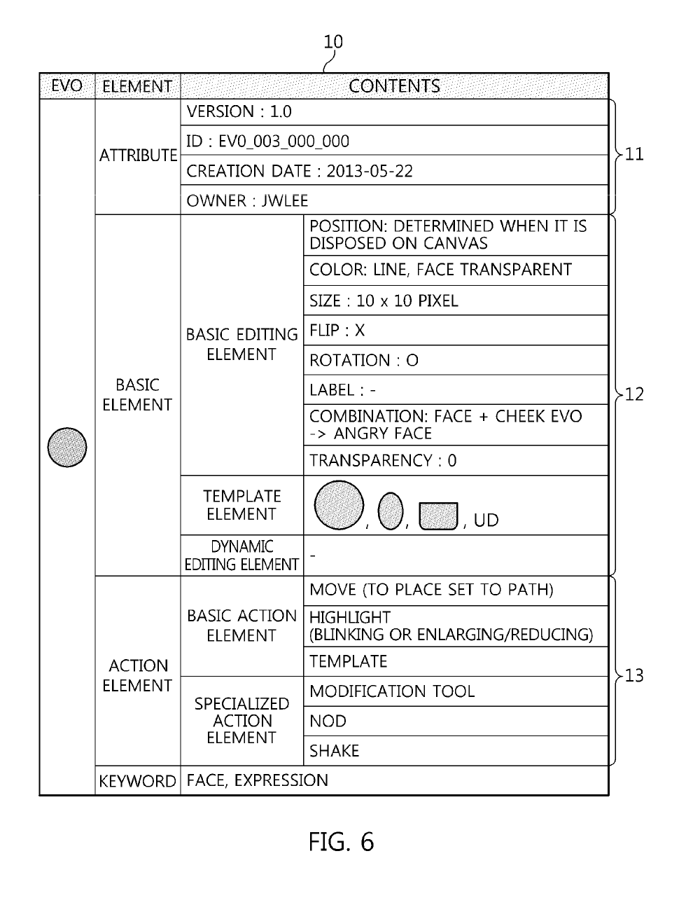

FIGS. 5 and 6 are diagrams illustrating the creation of editable visual objects related to “mouth” and “face”, respectively.

Similarly, when the object information input unit 120 inputs “mouth” or “face” as information about an editable visual object from the user, the template display unit 130 searches the template DB 150 for basic templates related to “mouth” or “face”, and displays found basic templates in the corresponding editing elements. Further, if the user changes values with respect to the respective editing elements displayed on the interface 10, as shown in the drawing, the visual object creation unit 140 may create an editable visual object having the shape of a mouth speaking while laughing, or an editable visual object having the shape of a face when nodding a head, based on the changed values.

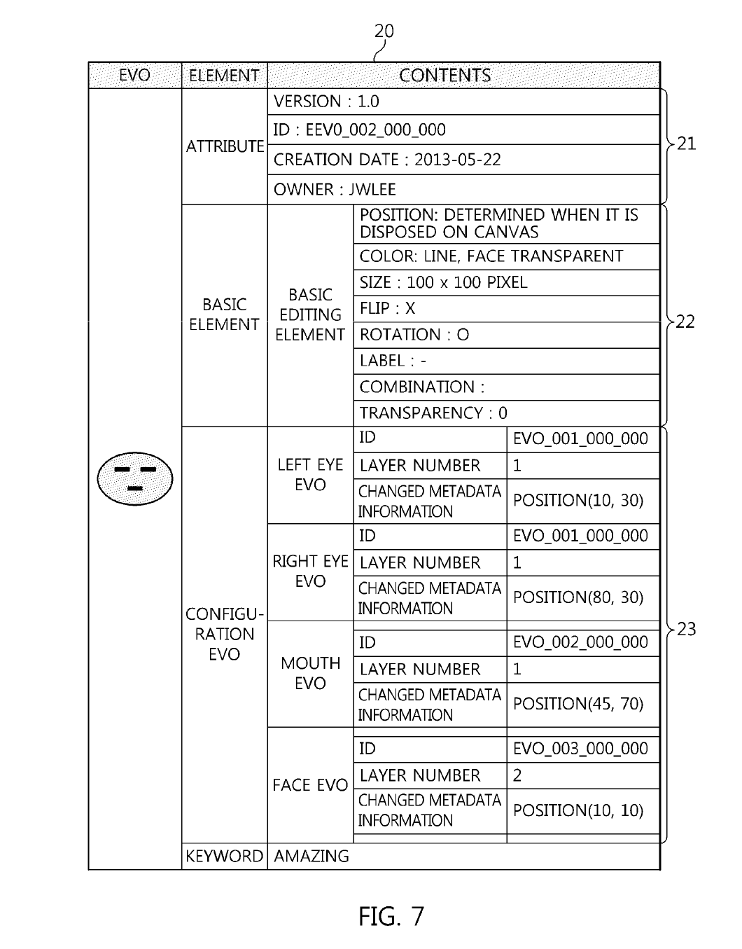

FIG. 7 is a diagram showing another embodiment of an interface provided by the apparatus for creating an editable visual object according to the embodiment of FIG. 3.

FIG. 7 illustrates the creation of editable visual objects for expression by combining editable visual objects for eyes, a mouth, and a face.

Similarly, when the user inputs “eyes,” “mouth,” and “face” as editable visual object information desired to be combined with each other, the interface unit 110 may display an interface 20 on the terminal of the user, as shown in the drawing. In this case, the interface 20 may include an attribute element area 21, a basic element area 22, and a configuration EVO area 23.

The template display unit 130 displays basic templates for a left eye, a right eye, a mouth, and a face in the respective editing element areas 21, 22, and 23. In this case, among various editing elements of each editable visual object, only elements that may be changed via combination may be displayed. For example, as shown in the drawing, position elements may be displayed in the configuration EVO so that the position information of the left eye, right eye, mouth, and face may be changed.

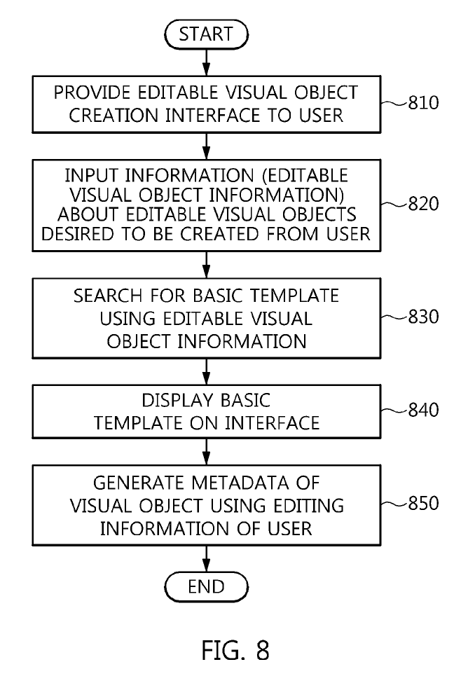

FIG. 8 is a flowchart showing a method of creating an editable visual object according to an embodiment.

FIG. 8 may be an embodiment of a visual object creation method performed by the editable visual object creation apparatus 100 of FIG. 3.

Referring to FIG. 8, the editable visual object creation apparatus 100 may provide an interface to the user so that editable visual objects may be created at step 810. As shown in FIGS. 4 to 7, the interface may display various editing elements so that users may easily edit the editable visual objects, wherein the editing elements may be displayed via various graphical elements.

Next, information about the editable visual objects to be created, for example, targets such as “eyes”, “mouth”, and “face”, may be input by the user at step 820.

Then, basic templates of the corresponding editable visual objects may be searched for in the template DB using the information of the editable visual objects input by the user at step 830. In this case, the template DB may store the templates of editable visual objects created by users, as well as the templates of various editable visual objects previously created by a developer.

Thereafter, the found basic templates may be displayed on the interface at step 840. In this case, one or more areas for various editing elements that are editable by the user may be displayed on the interface, and the values of the corresponding basic templates are displayed as basic values in the respective areas.

Then, if the user checks the basic values displayed on the interface and changes the values of required editing elements, editable visual objects are created using pieces of changed editing information at step 850. In this case, the metadata of the created editable visual objects may be stored in the visual object DB.

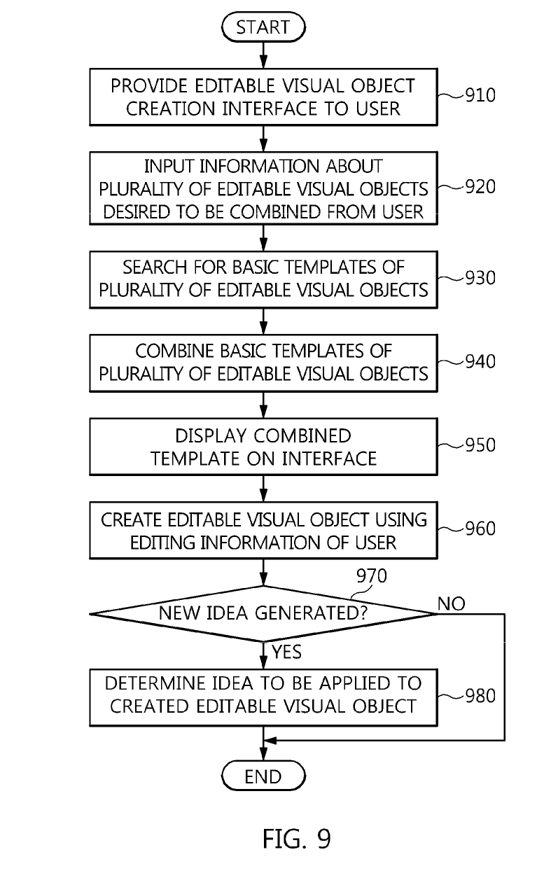

FIG. 9 is a flowchart showing a method of creating an editable visual object according to another embodiment.

Another embodiment of an editable visual object creation method performed by the editable visual object creation apparatus 100 of FIG. 3 will be described with reference to FIG. 9.

First, an interface is provided to the user so that editable visual objects may be created at step 910. In this case, as shown in FIG. 7, the provided interface may include an attribute element area, a basic element area, and a configuration EVO area in which editing elements of the respective editable visual objects to be combined may be changed.

Then, pieces of information about a plurality of editable visual objects to be combined are input by the user at step 920.

Next, basic templates for the information about the plurality of editable visual objects input by the user are searched for at step 930, and the templates of a plurality of found editable visual objects are combined with each other at step 940.

For example, if templates for left eye, right eye, mouth, and face objects are found, only values required to create a single expression object are extracted from the values of the templates of the respective editable visual objects, and thus the extracted values may be generated as editing elements for the “expression” object.

Next, if the templates of the plurality of editable visual objects are combined with each other, the combined template is displayed on the interface at step 950. That is, as illustrated above, if the templates of the left eye, right eye, mouth, and face objects may be combined with each other, and a template composed of editing elements for an expression object is created, the template may be displayed on the interface, as shown in FIG. 7.

Thereafter, if the user changes the editing elements on the interface, a new editable visual object is created based on the editing information at step 960.

Then, it is determined whether a new idea is generated for the newly created editable visual object at step 970. If it is determined that the new idea is generated, an idea to be applied to the created editable visual object may be determined at step 980.

In this case, an existing idea and the new idea may be presented to the user, and an idea to be applied to the editable visual object may be determined depending on selection information input by the user. Alternatively, any one of the existing idea and the new idea may be determined to be the idea to be applied to the editable visual object.

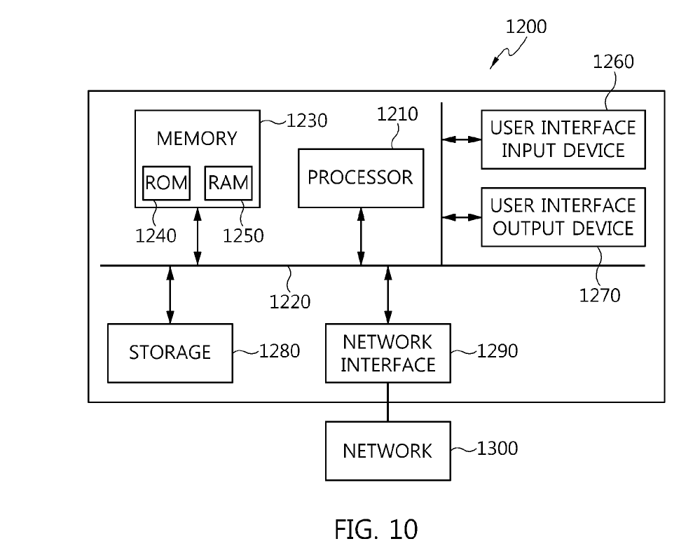

FIG. 10 is an embodiment of the present invention implemented in a computer system.

Referring to FIG. 10, an embodiment of the present invention may be implemented in a computer system, e.g., as a computer readable medium. As shown in in FIG. 10, a computer system 1200 may include one or more of a processor 1210, a memory 1230, a user interface input device 1260, a user interface output device 1270, and a storage 1280, each of which communicates through a bus 1220. The computer system 1200 may also include a network interface 1290 that is coupled to a network 1300. The processor 1210 may be a central processing unit (CPU) or a semiconductor device that executes processing instructions stored in the memory 1230 and/or the storage 1280. The memory 1230 and the storage 1280 may include various forms of volatile or non-volatile storage media. For example, the memory may include a read-only memory (ROM) 1240 and a random access memory(RAM) 1250.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

The present invention is advantageous in that a user may freely edit and create editable visual objects depending on his or her clothes via an editable visual object creation apparatus which supports intuitive and visual communication.

Further, the present invention is advantageous in that various editable visual objects created by the user may be utilized for various services such as tourism, an educational field such as foreign language learning, and game or chatting.

Those skilled in the art to which the present embodiments pertain will appreciate that the present invention may be implemented in other detailed forms without changing the technical spirit or essential features of the present invention. Therefore, the above-described embodiments should be understood to be exemplary rather than restrictive in all aspects.

What is claimed is:

1. An apparatus for creating an editable visual object, comprising:
an interface unit for providing an editable visual object creation interface to a user;
a template display unit for displaying a basic template for an editable visual object desired to be created by the user on the interface; and
a visual object creation unit for, if the user edits the displayed basic template, creating an editable visual object based on editing information.

2. The apparatus of claim 1, wherein the interface unit displays an authoring tool for editing one or more of an attribute element, a basic element, and an action element of the editable visual object on the interface.

3. The apparatus of claim 2, wherein the attribute element includes one or more of version, identification (ID), creation date, and user attributes of the editable visual object.

4. The apparatus of claim 2, wherein the basic element includes one or more of a basic editing element and a dynamic editing element for the editable visual object.

5. The apparatus of claim 4, wherein the basic editing element includes one or more of a position, at which the editable visual object is to be disposed, and a color, a size, flip/non-flip, and rotation/non-rotation of the editable visual object.

6. The apparatus of claim 4, wherein the dynamic editing element includes one or more action elements previously generated based on actions that can be taken by the editable visual object.

7. The apparatus of claim 2, wherein the action element includes one or more of a basic action element and a specialized action element for the editable visual object.

8. The apparatus of claim 7, wherein the basic action element includes one or more predefined action elements applicable to two or more editable visual objects.

9. The apparatus of claim 7, wherein the specialized action element includes one or more action elements determined based on the basic element edited by the user for the editable visual object.

10. The apparatus of claim 1, wherein the template display unit is configured to, if information about the editable visual object is input by the user, search a template database (DB) for a basic template of the editable visual object using the editable visual object information, and display a found basic template on the interface.

11. The apparatus of claim 1, wherein the visual object creation unit creates a new editable visual object by combining two or more editable visual objects selected by the user, and if a new idea is generated for the created new editable visual object, determines an idea to be assigned to the new editable visual object.

12. A method for creating an editable visual object, comprising:
providing an editable visual object creation interface to a user;
displaying a basic template for an editable visual object desired to be created by the user on the interface; and
if the user edits the displayed basic template, creating an editable visual object based on editing information.

13. The method of claim 12, wherein providing the interface comprises displaying an authoring tool for editing one or more of an attribute element, a basic element, and an action element of the editable visual object on the interface.

14. The method of claim 13, wherein the basic element includes one or more of a basic editing element and a dynamic editing element for the editable visual object.

15. The method of claim 13, wherein the action element includes one or more of a basic action element and a specialized action element for the editable visual object.

16. The method of claim 15, wherein the basic action element includes one or more predefined action elements applicable to two or more editable visual objects.

17. The method of claim 15, wherein the specialized action element includes one or more action elements determined based on a basic element edited by the user for the editable visual object.

18. The method of claim 12, wherein creating the visual object comprises:
inputting information about two or more editable visual objects selected by the user;
combining the selected two or more editable visual objects to create a new editable visual object; and
if a new idea is generated for the created new editable visual object, determining an idea to be assigned to the new editable visual object.
